(19) United States
(12) Patent Application Publication
(10) Pub. No.: US 2004/0246341 A1
(43) Pub. Date: Dec. 9, 2004

(54) Battery charger using USB and digital camera having the same

(75) Inventors: Yoo-shin Lee, Seoul (KR); Hyung-moo Huh, Seoul (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/771,669

(22) Filed: Feb. 4, 2004

(30) Foreign Application Priority Data
Jun. 3, 2003 (KR) 2003-35559

(51) Int. Cl. H04N 5/225

(52) U.S. Cl. 348/207.99

(57) ABSTRACT

An apparatus for charging a battery of a portable electronic device connected to a computer by USB by receiving power from the computer through USB, the apparatus includes a control portion to generate charge control signals corresponding to a battery selected according to a battery selection signal that is externally input, and a charging portion to charge the selected battery according to the charge control signals from the control portion.

This application claims priority to Korean Patent Application No. 2003-35559, filed on Jun. 3, 2003, in the Korean Intellectual Property Office, the disclosure of which is incorporated herein in its entirety by reference.

### FIELD OF THE INVENTION

The present invention relates to a battery charger using a universal serial bus (USB) port and a digital camera having the same, and more particularly, to a battery charger using USB installed in a portable electronic device, which is connected to a computer by USB and charges various types of batteries by receiving power from the computer through the USB, and a digital camera having the same.

### BACKGROUND OF THE INVENTION

Recently, the use of portable electronic devices such as digital cameras has grown rapidly. A digital camera is connected to a USB port to transfer photographed image files to a computer or other storage medium. Typically, the USB port includes a pair of data ports for data transmission and a pair of power ports for connection to a power supply.

Japanese Patent Publication No. 2001-125689 discloses a method and apparatus for supplying power to a portable electronic device using a USB port. In the patent, a secondary battery is charged by supplying power from a computer used as a host to a mobile phone corresponding to a peripheral using a USB port.

FIG. 1 is a view illustrating a conventional mobile phone receiving power from a computer by USB. FIG. 2 is a block diagram showing a method of supplying power to the mobile phone of FIG. 1.

Referring to FIGS. 1 and 2, a mobile phone 61 is connected to a computer 62 by USB. That is, a USB connection port 63 of the mobile phone 61 is connected to a USB connection port 64 of the computer 62 by a USB cable 65. The computer 62 receives power from a typical AC power source 67, for example, 220 V AC, through a power cable 66. Alternatively, the computer 62 may receive power through an adaptor 68 which converts AC power to DC power, for example, 5 V DC, used in the computer 62.

The connection between the computer 62 and the mobile phone 61 using the USB cable 65 is made by a pair of power ports and another pair of data ports. The USB connection port 63 of the mobile phone 61 includes a regulator 631 and a USB controller 632. The regulator 631 converts the input from the power connection 4.5 V and ground connection GND received from the computer 62 to a voltage used in the mobile phone 61 and supplies the voltage to a battery management system 69 in the mobile phone 61 so that the power needed for the mobile phone 61 to operate is supplied. The USB controller 632 is connected to the USB connection port 64 of the computer to input and output the data D+ and D− and to a main controller (not shown) of the mobile phone 61.

Unlike mobile phones that only use lithium-ion (Li—ion) batteries, typical portable electronic devices, such as digital cameras, use various types of batteries such as nickel metal hydride (Ni—MH), nickel cadmium (Ni—Cd), or Li—ion. Each type of battery has a distinctively different level of charging voltage and charging method, according to the type of battery. Thus, appropriate charging conditions and methods must be applied according to the type of battery.

However, in mobile phones, since a fixed voltage drop of the USB port using a general regulator is performed, charging is not performed according to the type of battery. Thus, the Li—ion battery may explode if the voltage increases over a predetermined value, due to the characteristic of the Li—ion battery.

### SUMMARY OF THE INVENTION

To solve the above problem, the present invention provides a battery charger using a USB port installed in a portable electronic device, which is connected to a computer by a USB port and can charge a variety of batteries by receiving power from the computer by the USB connection, and a digital camera having the same.

An embodiment of the present invention is directed to an apparatus for charging a battery of a portable electronic device connected to a computer by a USB port by receiving power from the computer through the USB connection. The apparatus includes a control portion to generate charge control signals corresponding to the battery selected according to a battery selection signal that is externally input, and a charging portion to charge the selected battery according to the charge control signals from the control portion.

The control portion is a main controller of the portable electronic device. The charge control signals of the control portion include a charge start signal to enable output of the charging portion, a battery type signal to control the output voltage level according to the battery selection signal, and a charge voltage control signal and a charge current control signal which are generated by receiving a charge current and a charge voltage from the charging portion to control the charge current and the charge voltage.

Another embodiment of the present invention is directed to a digital camera connected to a computer by USB to charge a battery by receiving power from the computer through the USB port. The digital camera contains a USB charger, including a USB controller to transmit and receive data through a USB port of the computer, a control portion to generate charge control signals corresponding to a battery selected according to a battery selection signal that is externally input, and a charging portion to charge the selected battery according to the charge control signals from the control portion, a charging portion to charge at least one among the various types of batteries, a control portion to control a charging operation of the charging portion, a main controller to transmit and receive data with the USB controller, and a power converting portion to receive power from the battery that is charged by the charger and generate and output power having a plurality of voltage levels.

The charge control signals of the control portion include a charge start signal to enable output of the charging portion, a battery type signal to control an output voltage level according to the battery selection signal, and a charge voltage control signal and a charge current control signal which are generated by receiving a charge current and a charge voltage from the charging portion to control the charge current and the charge voltage.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view illustrating a conventional mobile phone receiving power from a computer by USB;

FIG. 2 is a block diagram illustrating a method of supplying power to the mobile phone of FIG. 1;

FIG. 3 is a block diagram illustrating a battery charger using USB according to a preferred embodiment of the present invention;

FIG. 4 is a block diagram illustrating the inner structure of the USB battery charger of FIG. 3;

FIG. 5 is a circuit diagram of the charging portion of FIG. 3;

FIG. 6 is a view illustrating a digital camera connected to a computer by USB according to a preferred embodiment of the present invention;

FIG. 7 is a block diagram illustrating the inner structure of the digital camera of FIG. 6 connected to the computer by USB;

FIG. 8 is a perspective view illustrating the front and upper surfaces of a typical digital camera of FIG. 6;

FIG. 9 is a rear view of the digital camera of FIG. 8;

FIG. 10 is a view illustrating the configuration of the light incident side of the digital camera 1 of FIG. 8; and

FIG. 11 is a block diagram illustrating the overall structure of the digital camera 1 of FIG. 8.

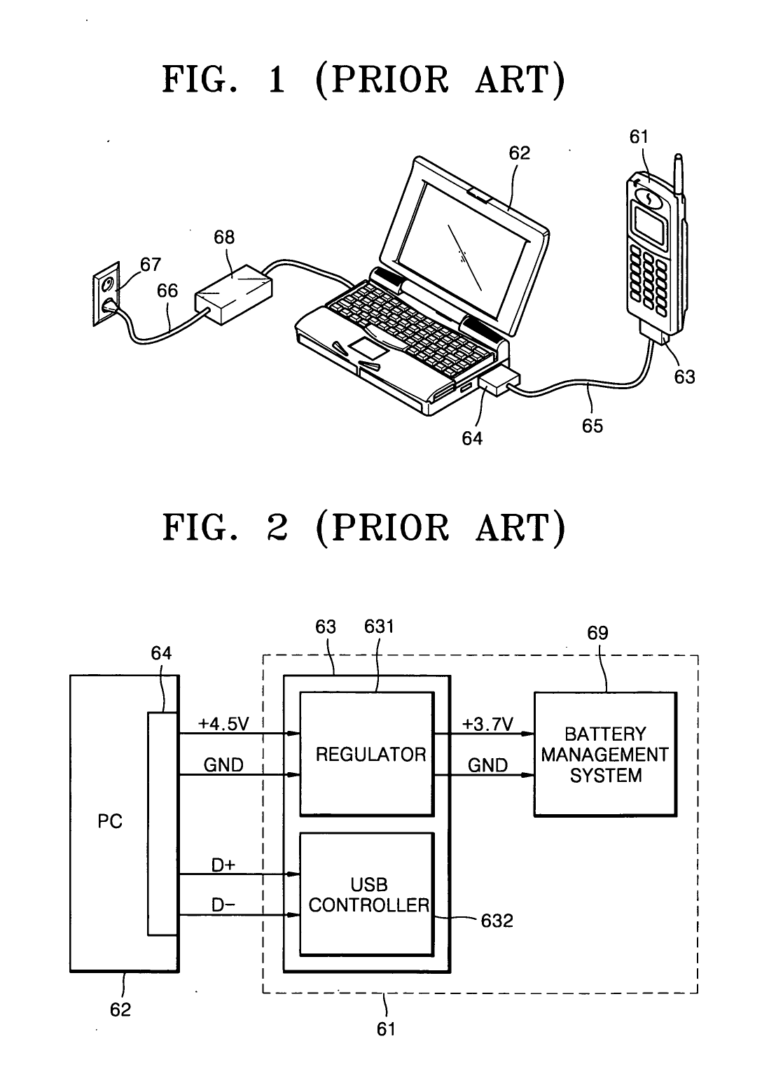

### DETAILED DESCRIPTION OF THE INVENTION

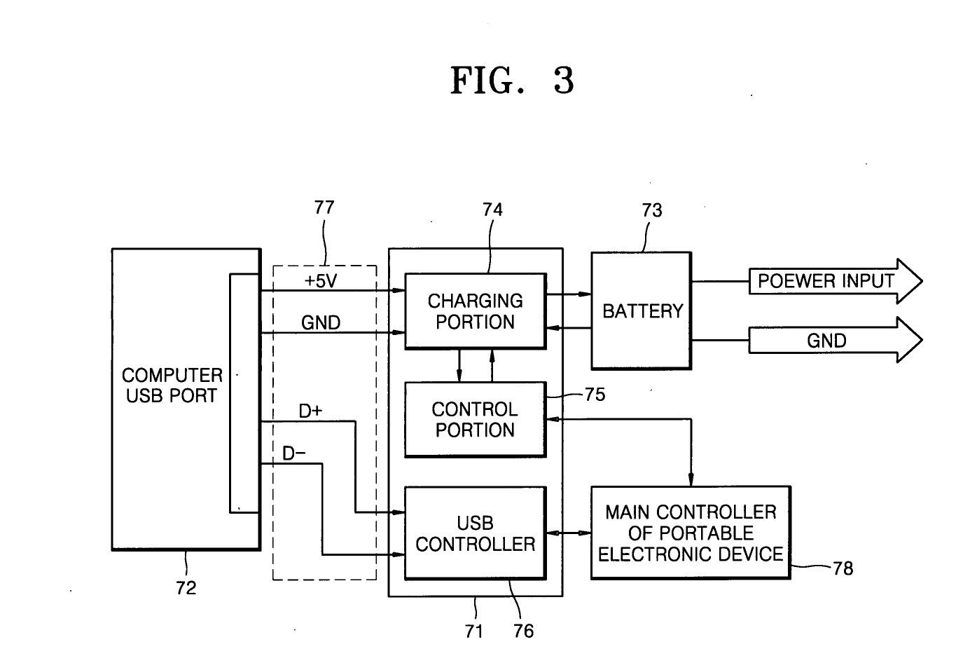

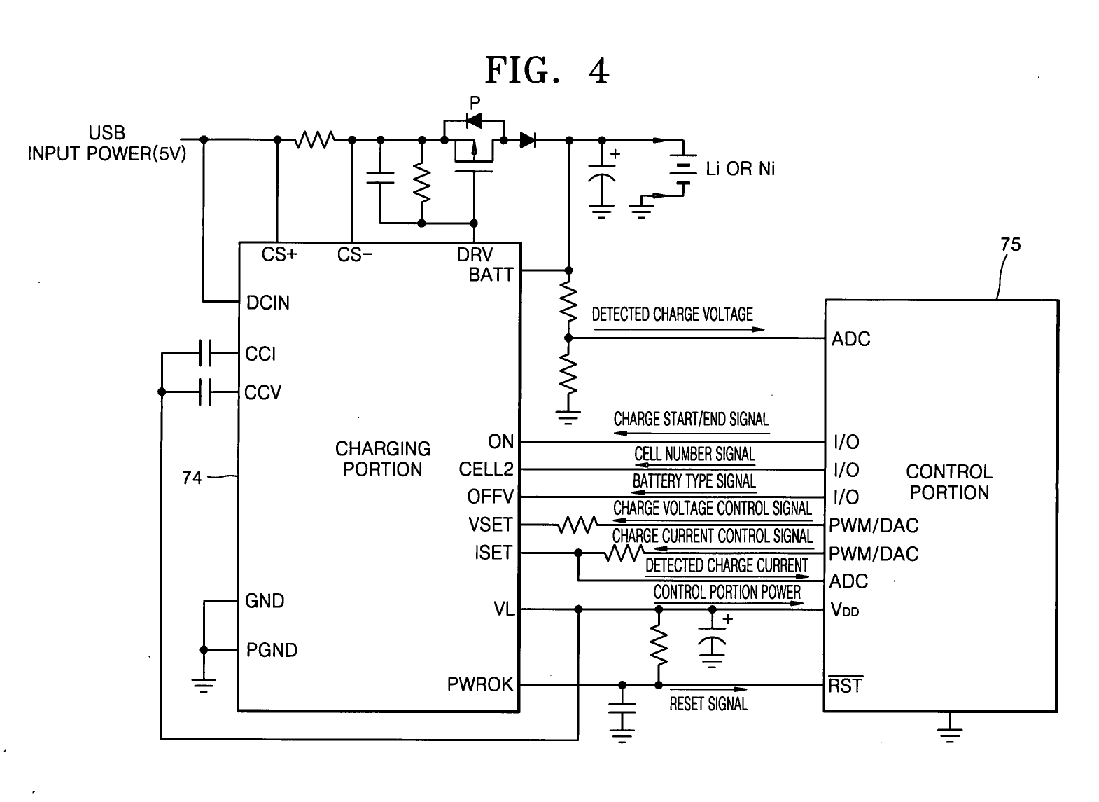

Referring to FIGS. 3, 4, and 5, a USB battery charger 71 includes a charging portion 74 and a controlling portion 75. The USB battery charger 71 charges a battery 73 of a portable electronic device, which is connected to a computer by USB, by receiving power from the computer via USB.

The USB battery charger 71 is connected to a USB port 72 of the computer by a USB cable 77. The USB cable 77 is preferably formed of a pair of power connection lines 5 V and GND and a pair of data connection lines D+ and D−, like a typical USB cable.

The charging portion 74 charges the various types of batteries that are installed in a portable electronic device and preferably is controlled by the control portion 75 while being connected to the control portion 75 and transmitting and receiving various signals therebetween. However, the charging portion 74 can be configured without the control portion 75, depending on the structure of the circuit portion constituting the charging portion 74.

The control portion 75 is connected to a main controller 78 of the portable electronic device and receives a battery selection signal through the main controller 78. The battery selection signal can be input by a user or recognized by a battery recognition apparatus that is additionally provided.

The control portion 75 is connected to the charging portion 74 and controls a charging operation of the charging portion 74. Alternatively, the main controller 78 of the portable electronic device, to which the USB battery charger 71 is connected, can be used instead of the control portion 75.

A USB controller 76, connected to the computer USB port 72 by the USB cable 77, controls the input/output of data D+ and D−between the computer and the portable electronic device's main controller 78. For a digital camera, image data can be transmitted between the computer and the digital camera. The battery 73 charged by the USB battery charger 71 supplies power to the portable electronic device.

Various input and output ports are formed in both the control portion 75 and the charging portion 74 so that various signals are transmitted between the control portion 75 and the charging portion 74. The control portion 75 receives a detected charge voltage, a detected charge current, a reset signal, and a control portion power, from the charging portion 74. The charging portion 74 receives a charge start/end signal, a cell number signal, a battery type signal, and a charge current/voltage control signal from the control portion 75.

The control portion 75 outputs the charge start signal and the battery type signal to the charging portion 74 to initiate charging of the battery 73. Also, the control portion 75 receives the detected charge current and the detected charge voltage from the charging portion 74 and generates a charge voltage control signal and the charge current control signal to be output to the charging portion 74. Thus, the charging portion 74 charges the battery 73 according to the type of battery installed.

The control portion 75 preferably includes at least one analog-to-digital converter (ADC). The ADC receives a detected analog charge voltage and detected charge current from the charging portion 74 and processes the detected voltage and current in the control portion 75.

The control portion 75 preferably includes a plurality of typical input/output (I/O) ports to output the charge start/end signal, the cell number signal, and the battery type signal. Also, the control portion 75 preferably includes a pulse with modulation and digital-to-analog converter (PWM/DAC) to receive and process the detected charge voltage and the detected charge current from the charging portion 74 and outputs the charge voltage control signal and the charge current control signal to a VSET port and an ISET port of the charging portion 74.

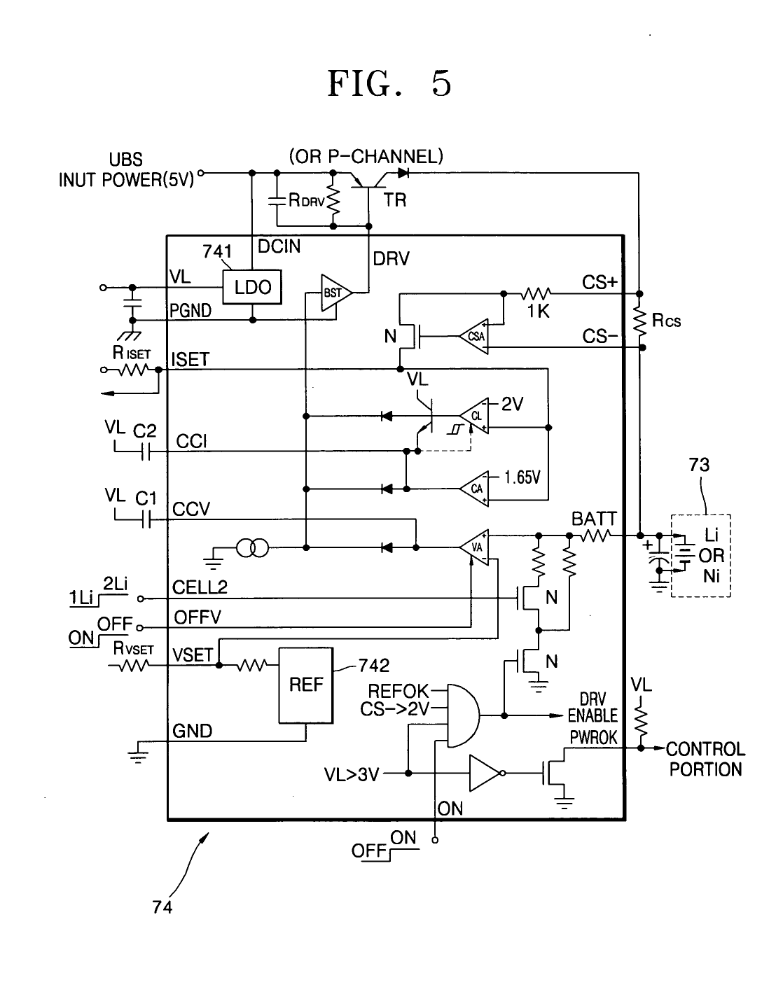

Furthermore, the control portion 75 operates by receiving power through a power port V_{DD}. The power to the control portion is generated by receiving USB input power from a linear regulator LDO of the charging portion 74 shown in FIG. 5, charging a voltage level of the USB input power and transmitting the power through a power output port VL.

According to the present invention, a battery in a portable electronic device is charged by receiving power through USB from a computer that is a host. Thus, the battery can be charged anywhere there is a computer, without a charger using regular power.

Various types of batteries, such as lithium-ion, nickel metal hydride, or nickel cadmium, can be efficiently charged by receiving power through USB by a method wherein various types of batteries included in the portable electronic device are charged according to their characteristics.

Referring to FIG. 5, the USB battery charger 71 of FIG. 4 includes the charging portion 74 and receives USB input power, for example, 5 V in the present preferred embodiment, and generates a constant voltage output of 3.3 V to charge the battery 73. The battery 73 may be, but is not limited to, nickel metal hydride, nickel cadmium or lithium-ion, and can be charged by the charging portion 74 according to the battery type.

The charging portion 74 preferably has three blocks including a linear regulator (low dropout linear regulator (LDO)) 741, a reference voltage generating portion 742, and a voltage/current regulator. The linear regulator 741 is a linear regulator having a 3.3 V output VL. The output VL provides power for the control portion 75 or other devices, and the output port of VL functions to prevent short-circuiting.

The reference voltage generating portion 742 detects and supplies a more accurate voltage to charge a lithium-ion battery since a lithium-ion battery can possibly explode. The reference voltage generating portion 742 can be embodied in a manner of distributing a voltage into an internal 2% 20K resistor and an external resistor R_{VSET}. This is important for the life span of the lithium-ion battery and optimal capacity.

The voltage/current regulator, which is widely distributed in the charging portion 74, preferably includes an attenuator, a current sense amplifier (CSA), a voltage regulation loop compensator (CCV), and a current regulation loop compensator (CCI).

The attenuator externally sets the number of cells of batteries input through a predetermined port CELL2 from the control portion 75. The current sense amplifier detects the current of the battery from an external detection resistor R_{cs} and an external load resistor R_{ISET} to perform various operations with other function blocks. The charge current is determined by the detection resistor R_{cs} and the load resistor R_{ISET}.

The voltage regulation loop compensator and the current regulation loop compensator form a separate loop to individually compensate for voltage and current by using external capacitors C1 and C2 connected to CCV port and CCI port, respectively, so that a charge can be stably performed. Each of the loops is completed by a P channel field effect transistor MOSFET or a PNP transistor (TR) connected externally.

CS+ and CS− are ports to detect current, DCIN is a port to receive USB input power, BATT is a battery power output port, ON is a port to receive a charge start/end signal from the control portion 75, CELL2 is a port to receive cell number signal of a battery to be charged, and OFFV is a port to receive the battery type signal.

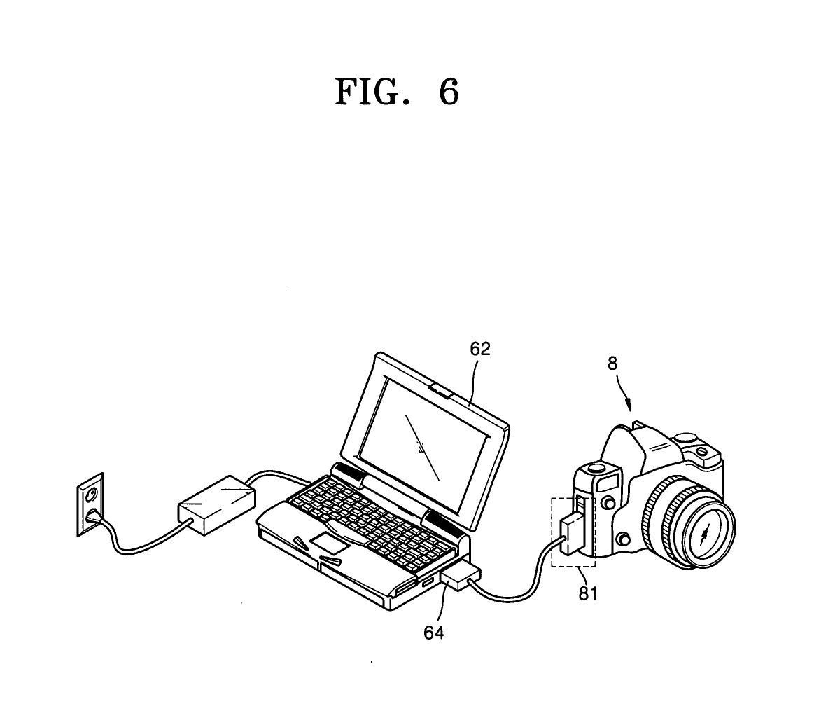

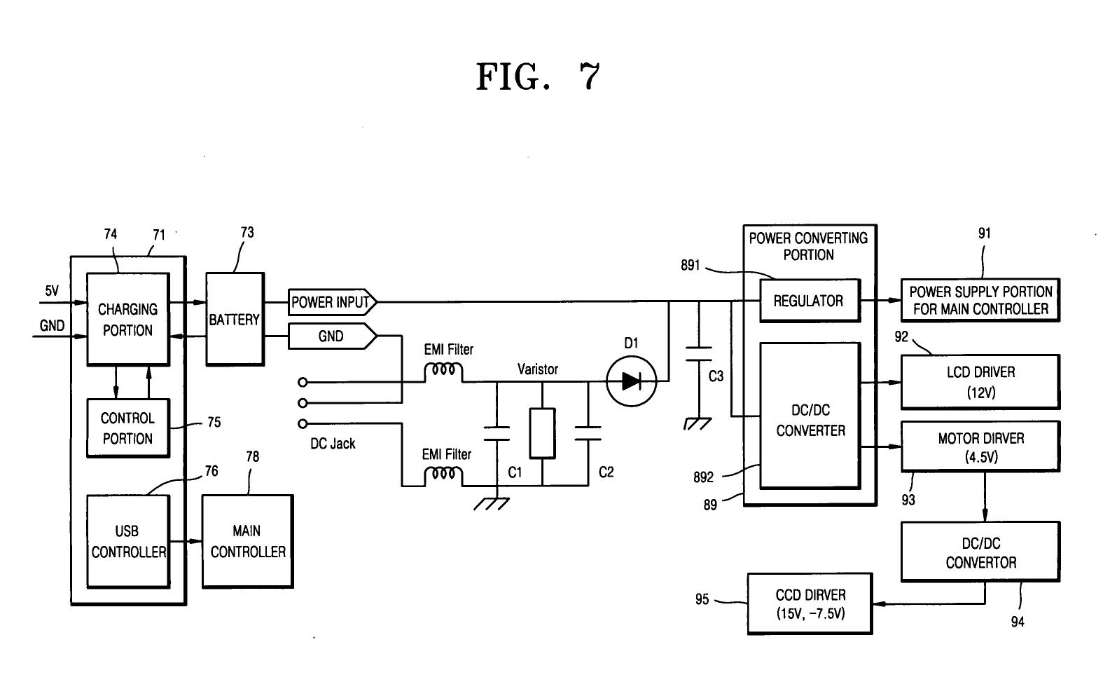

FIG. 6 is a view illustrating a digital camera connected to a computer by USB according to a preferred embodiment of the present invention. FIG. 7 is a block diagram illustrating the inner structure of the digital camera of FIG. 6 connected to the computer by USB.

Referring to FIGS. 6 and 7, a digital camera 8 having the USB battery charger 71 is connected to the computer 62 by USB to charge the battery 73 by receiving power from the computer 62 through a USB cable and includes the USB battery charger 71, the main controller 78, and a power converting portion 89. Since the constituent elements having the same reference numbers as those described with reference to FIGS. 3 through 5 are the same constituent elements and have the same functions, detailed description thereof will be omitted.

The USB battery charger 71 includes the USB controller 76, the charging portion 74, and the control portion 75. The USB controller 76 transmits and receives data through the USB port of the computer. The charging portion 74 charges at least one of the various types of batteries. The control portion 75 controls the charging operation of the charging portion 74.

The main controller 78 controls the overall operation of the digital camera 8 by transceiving data with the USB controller 76. The power converting portion 89 receives power from the battery 73 charged by the USB battery charger 71 and generates and outputs power having a plurality of voltage levels.

The power converting portion 89 includes a regulator 891 and a DC/DC converter 892 to generate voltages having various levels needed by the digital camera 8. Power generated from the power converting portion 89 is supplied to various portions needing power such as a power supply portion 91 for a main controller 78, an LCD driver 92, a motor driver 93, a DC/DC converter 94, and a CCD driver 95.

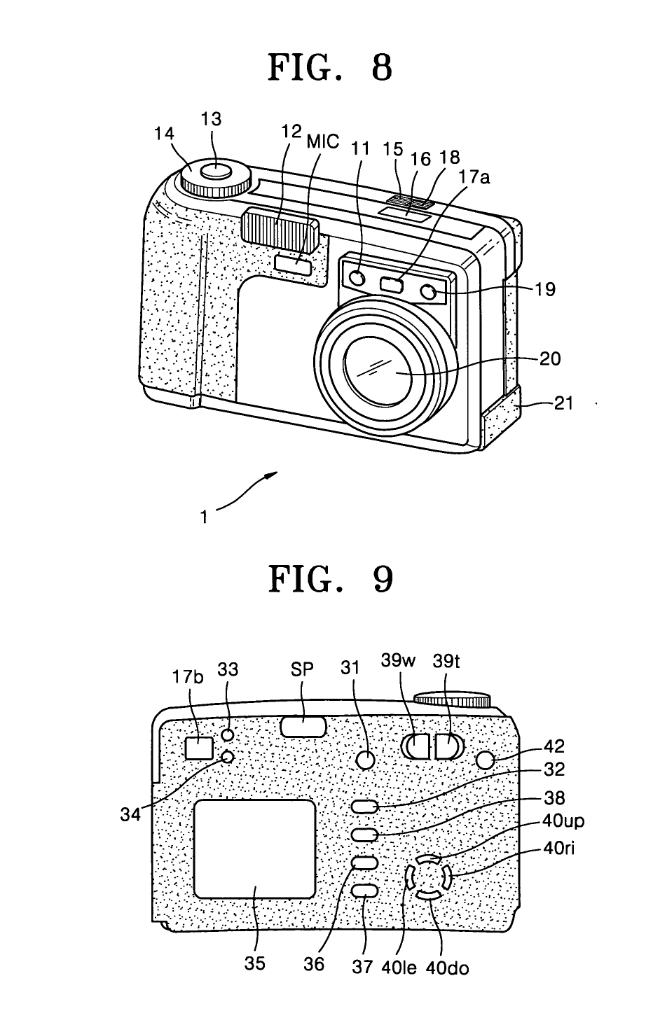

FIG. 8 is a perspective view illustrating the front and upper surfaces of a typical digital camera. Referring to FIG. 8, a microphone MIC, a self-timer lamp 11, a flash 12, a shutter button 13, a mode dial 14, a function selection button 15, a photographing information display portion 16, a viewfinder 17a, a function block button 18, a flash light amount sensor 19, a lens portion 20, and an external interface portion 21 are arranged on the front and upper surfaces of a typical digital camera 1.

FIG. 9 is a rear view of the digital camera shown in FIG. 8. Referring to FIG. 9, a representative voice button 42, a speaker SP, a power button 31, a monitor button 32, an automatic focus lamp 33, a viewfinder 17b, a flash ready lamp 34, a display panel 35, a confirm/cancel button 36, an enter/play button 37, a menu button 38, a wide-angle zoom button 39w, a telephoto zoom button 39t, an up movement button 40up, a right movement button 40ri, a down movement button 40do, and a left movement button 401e are arranged on the rear surface of a typical digital camera 1.

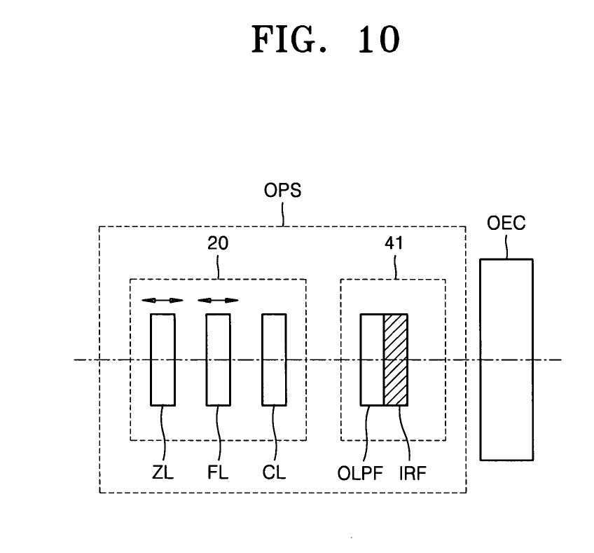

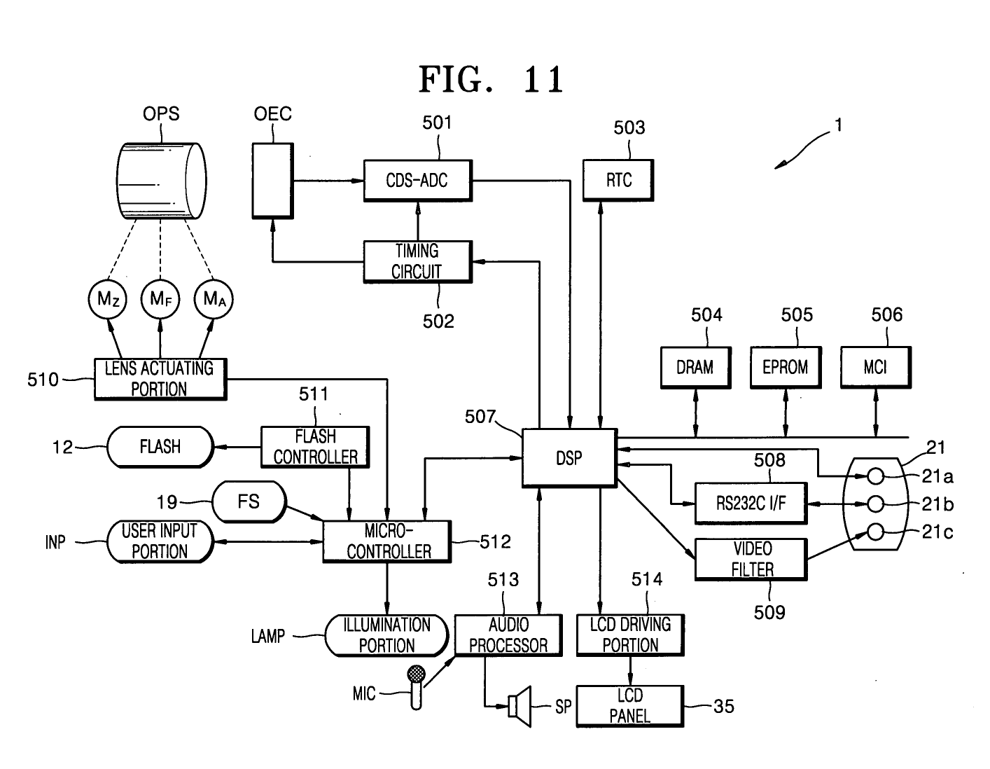

FIG. 10 shows the configuration of the light incident side of the digital camera 1 of FIG. 8. FIG. 11 shows the overall structure of the digital camera 1 of FIG. 8. Referring to FIGS. 10 and 11, the overall structure of the digital camera 1 of FIG. 8 is described below.

An optical system OPS including the lens portion 20 and a filter portion 41 optically processes light from an object to be photographed. The lens portion 20 of the optical system OPS includes a zoom lens ZL, a focus lens FL, and a compensation lens CL.

When the user presses the wide-angle zoom button 39w of FIG. 2 or the telephoto zoom button 39t of FIG. 9 included in a user input portion INP, a signal corresponding to the pressed button is transmitted to a microcontroller 512. Accordingly, as the microcontroller 512 controls a lens actuating portion 510, a zoom motor M_{Z} is actuated to move the zoom lens ZL.

The filter portion 41 of the optical system OPS includes an optical low pass filter OLPF which removes optical noise at a high frequency and an infrared cut filter IRF which cuts an infrared component of the incident light.

An optoelectric converting portion OEC of a CCD (charge coupled device) or a CMOS (complementary metal-oxide-semiconductor) converts light from the optical system OPS to an electric analog signal. A digital signal processor DSP 507 controls the operation of the optoelectric converting portion OEC and a CDS-ADC (correlation double sampler and analog-to-digital converter) device 501 as an analog-to-digital converting portion by controlling a timing circuit 502. The CDS-ADC device 501 processes the analog signal from the optoelectric converting portion OEC by removing high frequency noise and adjusting the amplitude thereof, to convert the processed analog signal to a digital signal. The digital signal processor DSP 507 processes the digital signal output from the CDS-ADC device 501 to generate a digital image signal divided into a brightness signal and a chrominance signal.

An illumination portion LAMP operated by the microcontroller 512 includes the self-timer lamp 11, the automatic focusing lamp 33 of FIG. 9, and the flash ready lamp 34 of FIG. 9. The user input portion INP includes the shutter button 13 of FIG. 8, the mode dial 14 of FIG. 8, the function selection button 15 of FIG. 8, the function block button 18 of the FIG. 8, the monitor button 32 of FIG. 9, the confirm/delete button 36 of FIG. 9, the enter/play button 37 of FIG. 9, the menu button 38 of FIG. 9, the wide-angle zoom button 39w of FIG. 9, the telephoto zoom button 39t of FIG. 9, the up movement button 40up of FIG. 9, the right movement button 40ri of FIG. 9, the down movement button 40do of FIG. 9, and the left movement button 401e of FIG. 9.

The digital image signal from the digital signal processor DSP 507 is temporarily stored in the DRAM (dynamic random access memory) 504. An EEPROM (electrically erasable programmable read only memory) 505 contains an algorithm and set data needed for the operation of the digital signal processor DSP 507. A user's memory card is detachably inserted in a memory card interface MCI 506.

The digital image signal from the digital signal processor DSP 507 is transmitted to a LCD driving portion 514 so that an image is displayed on the display panel 35.

The digital image signal from the digital signal processor 507 can be transmitted in a serial communication by a USB connection portion 21a, or an RS232C interface 508 and a connection portion 21b. The digital image signal can be transmitted as a video signal through a video filter 509 and a video output portion 21c.

An audio processor 513 outputs a voice signal from the microphone MIC to the digital signal processor DSP 507 or a speaker SP and an audio signal from the digital signal processor 507 to the speaker SP. The flash 12 is driven by the microcontroller 512 and a flash controller 511 according to the signal from the flash light amount sensor 19.

As described above, according to the USB battery charger and the digital camera having the same according to the present invention, a battery in a portable electronic device is charged by receiving power through USB from a computer that is a host. Thus, the battery can be charged anywhere there is a computer, without a charger using regular power.

Also, various types of batteries can be charged stably and efficiently by receiving power through USB by a method wherein various types of batteries in a portable electronic device, including, but not limited to, lithium-ion, nickel metal hydride, or nickel cadmium are charged according to their characteristics.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. An apparatus for charging a battery of a portable electronic device connected to a computer by USB by transferring power from the computer through the USB, the apparatus comprising:
a control portion to generate charge control signals corresponding to a battery selected according to a battery selection signal that is externally input; and
a charging portion to charge the selected battery according to the charge control signals from the control portion.

2. The apparatus of claim 1, wherein the charge control signals of the control portion comprise a charge start signal to enable output of the charging portion.

3. The apparatus of claim 1, wherein the charge control signals of the control portion comprise a battery type signal to control an output voltage level according to the battery selection signal.

4. The apparatus of claim 1, wherein the charge control signals of the control portion comprise a charge voltage control signal and a charge current control signal, which are generated based on the detection of a charge current and a charge voltage from the charging portion, to control the charge current and the charge voltage.

5. The apparatus of claim 1, wherein the control portion is a main controller of the portable electronic device.

6. The apparatus of claim 1, wherein the battery selection signal is input by a user.

7. The apparatus of claim 1, wherein the battery selection signal is input by a battery recognition apparatus.

8. A digital camera connected to a computer by USB to charge a battery by receiving power from the computer through USB, the digital camera comprising:
a USB charger including a USB controller to transmit and receive data through a USB port of the computer, a control portion to generate charge control signals corresponding to a battery selected according to a battery selection signal that is externally input, and a charging portion to charge the selected battery according to the charge control signals from the control portion;
a charging portion to charge at least one among the various types of batteries;
a control portion to control a charging operation of the charging portion;
a main controller to transmit and receive data with the USB controller; and
a power converting portion to receive power from the battery that is charged by the charger and generate and output power having a plurality of voltage levels.

9. The digital camera of claim 8, wherein the charge control signals of the control portion comprise a charge start signal to enable output of the charging portion.

10. The digital camera of claim 8, wherein the charge control signals of the control portion comprise a battery type signal to control an output voltage level according to the battery selection signal.

11. The digital camera of claim 8, wherein the charge control signals of the control portion comprise a charge voltage control signal and a charge current control signal which are generated by receiving a charge current and a charge voltage from the charging portion to control the charge current and the charge voltage.
